(19) United States
(12) Patent Application Publication
(10) Pub. No.: US 2018/0356005 A1
(43) Pub. Date: Dec. 13, 2018

(54) CROSS-SHAPED CLIP ARRANGEMENT FOR CLAMPS

(71) Applicant: FRONTEC INDÚSTRIA DE COMPONENTES DE FIXAÇÃO LTDA, Sãn Leopoldo (BR)

(72) Inventor: Davi Antônio Dalcin, São Leopoldo (BR)

(21) Appl. No.: 15/735,848

(22) PCT Filed: Apr. 29, 2016
(86) PCT No.: PCT/BR2016/050094

§ 371 Date: Dec. 12, 2017

(30) Foreign Application Priority Data
Jun. 12, 2015 (BR) BR2020150139158

(51) Int. Cl. F16L 3/04

(52) U.S. Cl. CPC F16L 3/04; F16B 5/123

(57) ABSTRACT

A CROSS-SHAPED CLIP ARRANGEMENT FOR CLAMPS comprises a cross-shaped clip (1) with four holding flanges (2) and four centring ridges (3) for centring the clip in the holes in the metal sheet and/or surface to which it is attached, thus enhancing the stability and centring the clip better in the base hole.

The present application refers to a Cross-Shaped Clip Arrangement For Clamps, particularly a clip endowed with a cross having four holding flanges, in addition to four centring ridges to the plating on which it is placed jointly with a clamp, preferably used to moor wires and cables, thus preventing undesirable movements after fastening thereof, enhancing the stability of the combination.

### FIELD OF THE INVENTION

The field of application of the present invention is conventional clamps for fastening wires, cables, hoses in holes made on plating or surfaces in general, either in the industrial segment or in the industry of home appliances, automobile or aircraft or any other industry, or in the ambit of the home or at a site where there is a need to fasten wires and cables to plating without the need for screws or rivets.

### STATE OF THE ART

Nylon® clamps have been known for a long time and are used for the most varied purposes, including fastening and assemblage of a handful of wires and cables in an organized manner. Technologies and accessories were aggregated thereto, further increasing their field of usage, such as, for example, greater resistance to traction, temperature and weathering in general. The current state of the art anticipates certain patent documents pertaining to the subject matter in question, that is, accessories applied and/or incorporated to clamps, such as MU 6802786 which refers to a flexible clamp endowed with means for fastening tubes and the like. This system provides means for fastening by gluing, thus preventing spiking by pins. This is possible thanks to a platform which receives a fine layer of glue duly protected by a flexible blade.

Despite performing the function well for which it was designed, the most severest use of this clamp such as, for example, in mooring cables and wires to plating and surfaces of while line equipment, it is not entirely trustworthy with chemical adhesiving alone.

The current state of the art also anticipates document JP 2009299851 A, which comprises a clip for fastening onto plating holes. Said clip comprises a cross formed by just two holding flanges and by two centring ridges. The cross is opposed to the receiving reel of the clamp rack.

The constructive arrangement above is much more convenient for fastening wiring to plating such as in the automobile industry and for white goods, for example, however it still has certain drawbacks such as the fact that, by having just two flanges and two ridges, it comes loose and/or shifts off-center more easily by the mechanical vibrations inherent to the working of the equipment.

### OBJECTIVES OF THE INVENTION

It is therefore an objective of the present invention to propose a clip which is inserted into a hole in any plating capable of promoting greater stability and reliability in fastening to the equipment, regardless of the inherent working vibrations.

It is another objective of the invention to promote enhanced concentricity and/or positioning between the clip and the base hole to certain plating.

### THE INVENTION

Thus, the present invention pertains to a cross-shaped clip endowed with four flanges which inserted into a base hole promote optimized stability and reliability in fastening to the plating, in addition to having four ridges which greatly assist in centring the clip in relation to said base hole, whereby facilitating both the assembly of the product and guaranteeing its stability throughout its use.

### DESCRIPTION OF THE DRAWINGS

The invention will now be described in terms of a preferred embodiment, and for improved understanding, references will be made to the accompanying drawings, which provide an illustrative but not limitative representation:

FIG. 1: Perspective view of the cross-shaped clip arrangement for clamps.

FIG. 2: Top view of the cross-shaped clip arrangement for clamps.

FIG. 3: Bottom view of the cross-shaped clip arrangement for clamps.

FIG. 4: Side view of the cross-shaped clip arrangement for clamps.

FIG. 5: Perspective view of the cross-shaped clip arrangement for clamps, showing use in a clamp.

FIG. 6: Side view of the cross-shaped clip arrangement for clamps, showing use in any plating.

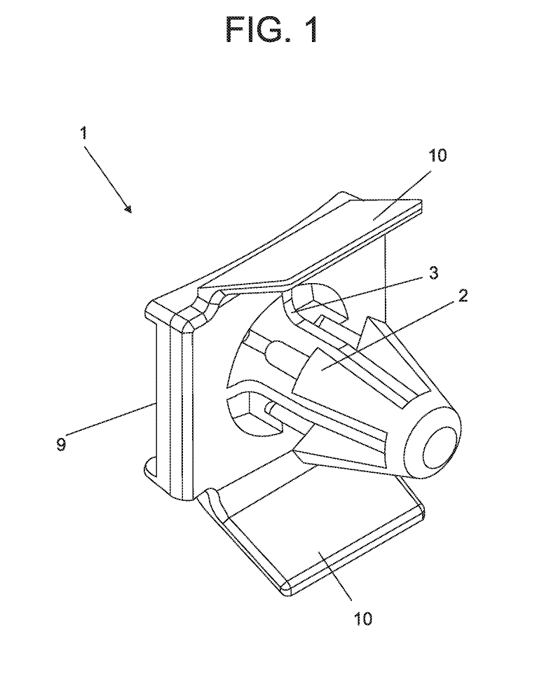

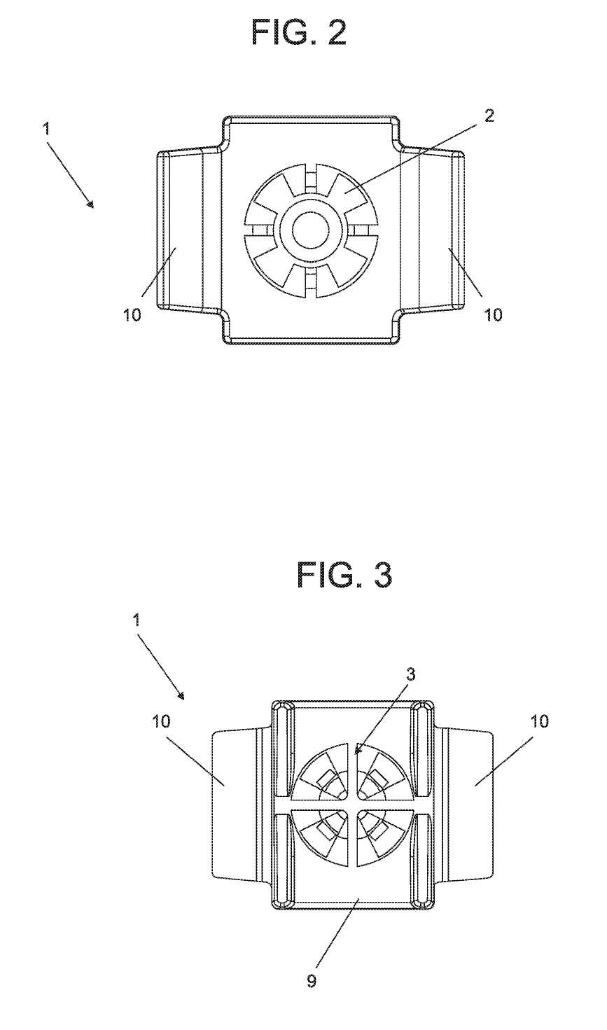

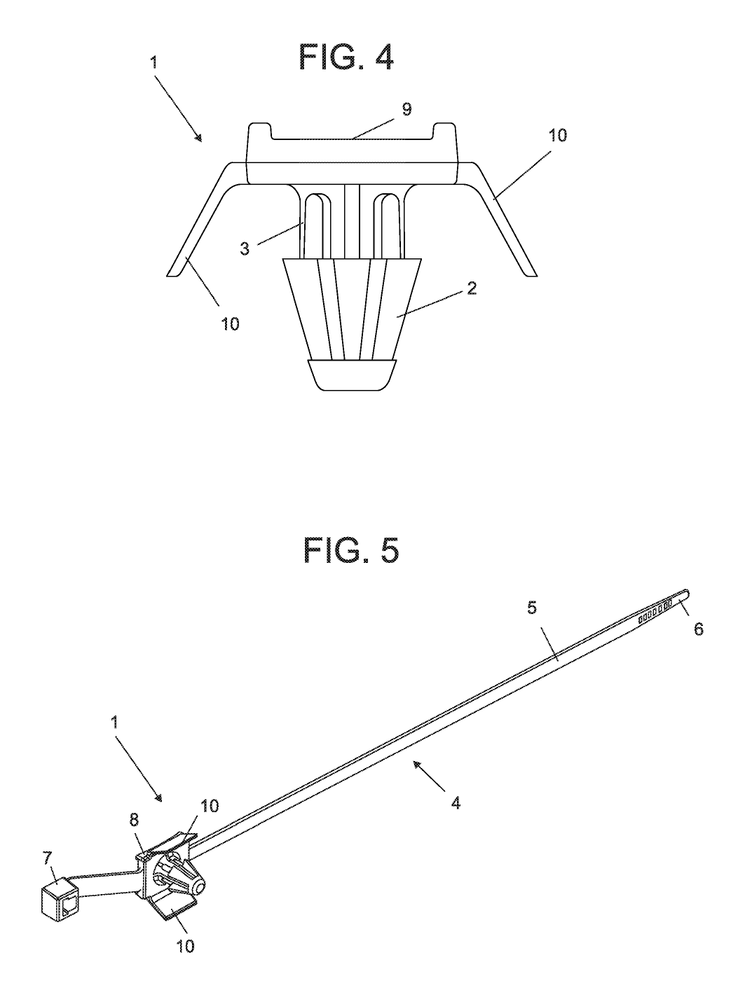

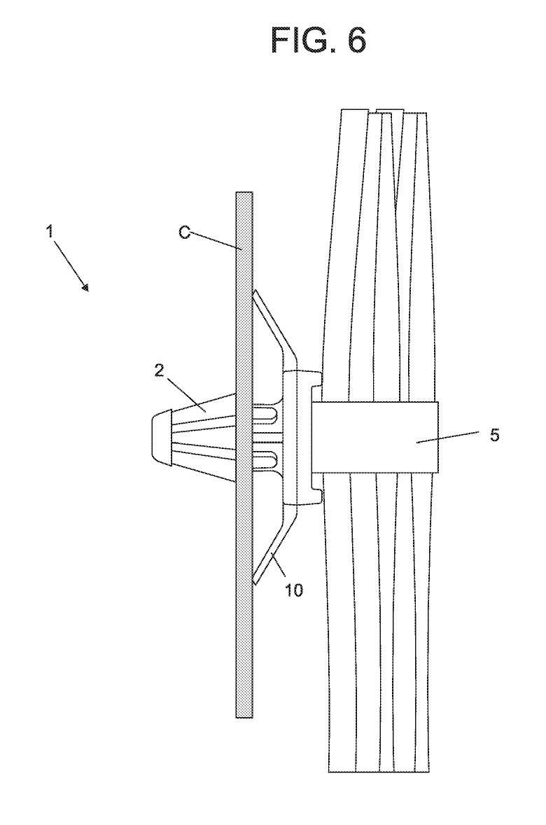

### DETAILED DESCRIPTION

The Cross-Shaped Clip Arrangement For Clamps, object of this patent application, comprises a cross-shaped clip (1) having four holding flanges (2) and four ridges (3) for centring over the hole of the plating and/or surface on which it is fastened, thus promoting greater stability and better centring over the base hole.

More particularly, the innovative clip (1) was designed to be used with a conventional clamp (4), preferably made of nylon®, which comprises an elongated slender body (5) ending in a tail (6) with serrated edging along said body (5) suitable for promoting mooring to the head (7), located in distal position, where a locking mechanism prevents slipping after insertion. The body (5) also has a clamp (4) comprising a clip (1) with a rectangular section base (8) where an equally sectioned hollow (9) traverses the body (5) of the clamp (1), and said base (8) sidewardly projects two slanted contact lapels (10). The clip (1) in reference centrally presents a cross-shaped truncated cone projection endowed with four holding flanges (2), with crescent radii from the upper end of said cross, and these flanges together provide optimized fastening of the clip (1) to the base hole of the plating on which it is fastened, also having four centring ridges (3), bordering the flanges (2), which jointly provide perfect concentricity between the clip (1) and the base hole.

Therefore, once a base hole is made in the plating, the clip (1) is introduced from above, that is, the blunt part of the truncated cone section of circular delineation, which facilitates entry thereof into said base hole. From then onwards, an effort is made in the sense that the holding flanges (2) traverse the entire base hole, and at the end of said path all the four flanges (2) equally saddle onto the surface of the plating, and since there are four it is harder for the clip (1) to escape compared to a conventional clip having just flanges. In the same way, the four centring ridges (3) provide improved condition for assembly, centralization and concentricity of the clip (1) in relation to the base hole preventing undesirable sideward displacement thereof.

Having described and illustrated the best form of realization currently foreseen for the embodiment of the present invention, however, it must be understood that the present invention is not limited to the practical aspects of the currently preferred realization, illustrated and described, and that all and such modifications and variations should be considered as being encompassed within the spirit and the scope of the invention.

1. CROSS-SHAPED CLIP ARRANGEMENT FOR CLAMPS with a rectangular section base (8) where an equal section hollow (9) traverses the body (4) of the clamp (4), and from said base (8) two slanted contact lapels (10) project sidewardly;
the clip (1) centrally presents a cross-shaped truncated cone projection characterized by denoting four holding flanges (2), with crescent radii from the upper end of said cross, also having four centring ridges (3) bordering the flanges (2).
